(19) United States
(12) Patent Application Publication
(10) Pub. No.: US 2016/0304029 A1
(43) Pub. Date: Oct. 20, 2016

(54) VEHICLE CAMERA ENCLOSURE

(71) Applicant: FORD GLOBAL TECHNOLOGIES, LLC, Dearborn, MI (US)

(72) Inventors: Francisco Javier VILLANUEVA, Los Pastores (US); Javier SANCHEZ, Mexico City (MX); Juan Esteban RIIVERA, Puebla (MX)

(21) Appl. No.: 14/689,339

(22) Filed: Apr. 17, 2015

(51) Int. Cl. B60R 1/00; H04N 5/225

(52) U.S. Cl. CPC B60R 1/00; H04N 5/2252

(57) ABSTRACT

A vehicle camera enclosure for enclosing a vehicle camera includes a housing having an inner edge defining an opening and a cover extending across the opening. The cover is outwardly rotatable away from the inner edge from a closed position to an open position.

### TECHNICAL FIELD

This disclosure relates to a vehicle camera enclosure, and in particular embodiments, relates to an enclosure for a translatable vehicle camera.

### BACKGROUND

Many current vehicles include driver assistance systems that provide information to a driver to actively or passively assist the driver. Certain driver assistance systems process information captured by sensors on the vehicle. For example, camera-based driver assistance systems are used as electronic parking aids. These systems typically include a camera integrated on the rear of the vehicle for recording images relating to space behind the vehicle. In certain systems, the camera is activated when a reverse gear is engaged, thereby recording camera images which are output to a user interface display. The camera is typically mounted to the outside of the vehicle, which exposes the camera to environmental conditions. The functionality of the camera may become compromised due to the buildup of film, grit and/or dirt on the camera lens. In order to reduce contamination in the region the camera, there exists a need for a vehicle camera enclosure to adequately protect the camera lens.

### SUMMARY

In at least one embodiment, a vehicle camera enclosure for enclosing a vehicle camera includes a housing having an inner edge defining an opening and a cover extending across the opening. The cover is outwardly rotatable away from the inner edge from a closed position to an open position.

In at least one embodiment, a vehicle camera enclosure for enclosing a vehicle camera includes a housing having an inner edge defining an opening and a cover extending across the opening. The cover includes inner and outer layers of different opaque materials.

In at least one embodiment, a vehicle camera system includes a camera and an enclosure configured to at least partially enclose the camera. The camera is translatable between inward and outward positions. The enclosure has an opening and a cover extending across the opening. The cover is configured to have closed and open positions.

### BRIEF DESCRIPTION OF THE DRAWINGS

FIG. 1 illustrates a front view of a vehicle camera system including a cover in a closed position;

FIG. 2 illustrates the vehicle camera system of FIG. 1 depicting the cover in an open position;

FIG. 3 illustrates a side view of the vehicle camera system as depicted in FIG. 1;

FIG. 4 illustrates the side view of the vehicle camera system as depicted in FIG. 2;

FIG. 5 illustrates a perspective view of a cover in the closed position in accordance with one embodiment of the present disclosure;

FIG. 6 illustrates a cross section view of the cover in the closed position depicted in FIG. 5 and taken along line 6-6;

FIG. 7 illustrates an exemplary vehicle camera system; and

FIG. 8 illustrates an exemplary method for control of a vehicle camera system with an enclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In one or more embodiments, a camera system is disclosed that has an enclosure including one or more flaps positioned to protect the camera lens when the camera is in an inward position. The cover is integrated with a soft material on one or more of the flaps to contact the lens when the camera is moving from an inward position to an outward position (e.g., operable state). The soft material on the one or more flaps is configured to contact the camera lens when the camera is moving (e.g., telescoping outwardly) through the cover. In one or more embodiments, the system may allow a user to make a request for the camera lens to be cleaned by controlling a cycle mode between the inward and outward positions such that the one or more flaps rotate from closed and open positions while the camera translates through the cover from an inward position (e.g., stored state) to an outward position (e.g., operable state).

For example, the cover may contact (e.g., brush) the camera lens as the camera moves to the inward position from the outward position. The cover may include an inner and outer layer of different opaque materials. The outer layer prevents the camera from being exposed to the external environment when the camera is in the stored state. The cover is configured so that as the camera translates to the operable state in the outward position, the cover rotates to an open position to expose the camera lens.

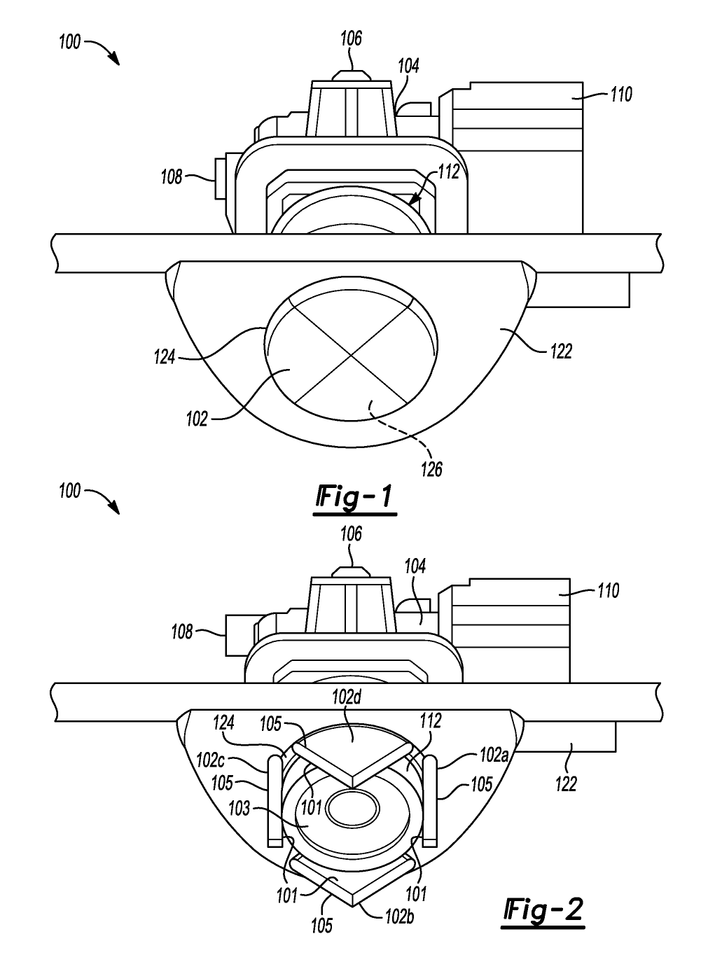

FIG. 1 illustrates a front view of a vehicle camera system 100 including a cover 102 in a closed position. The vehicle camera system 100 may include the camera 112, the cover (e.g., shroud) 102, a rack 106 and pinion 108 configured with a motor (not shown) in a cavity 104, and a housing 122 to receive the vehicle camera system 100. The housing 122 includes an inner edge 124 defining an opening 126 for the camera 112. The cover 102 extends across the opening 126 of the housing 122 and includes inner and outer layers of different opaque materials. The inner layer may be integrated with a fiber material on one or more flaps configured to contact the camera lens. For example, when the camera translates from an inoperable to operable state via the rack 106 and pinion 108, the cover 102 moves from the closed to an open position such that the one or more flaps contact the lens to remove debris while rotating to the open position.

The cover 102 may include an inner layer (e.g., the side facing the lens) formed of a fiber material. The fiber material may include cleaning fibers such as nylon, Kevlar™, polyester, and/or a combination of materials thereof. The fiber material may be a microfiber that is able to absorb oily matter without being abrasive. The fiber material may have electrostatic properties to give it a high dust-attracting material.

As shown in FIG. 1, the vehicle camera system 100 is illustrated with the camera 112 in the inward position (e.g., inoperable state) having the cover 102 enclosing the camera lens. In one example, the cover 102 may have one or more flaps adjacent to each other so that in the closed position the flaps contact each other to shroud the camera lens. The cover 102 may have the outer layer formed of a material that is rigid enough to keep the cover closed when the camera is in the inward position. The cover 102 may be biased towards the closed position facing the camera lens. The outer layer may comprise a polymeric material. The one or more flaps are hinged to rotate to the open position when the camera 112 comes into contact with the cover 102. The cover 102 may have an outer layer formed of polyethylene, polypropylene, polyvinyl chloride, polyamide, polysulfones, and/or a combination of material thereof.

In one example, a camera application may control the motor in the cavity 104 to move the pinion 108 along the rack 106 so that the camera 112 may translate from the inward position to the outward position to expose the camera lens. The camera 112 may have an electrical connector interface 110 that enables the camera 112 and motor to communicate with a processor. For example, an operable state command may be transmitted form a camera application executed at the processor to the vehicle camera system 100 via the electrical connector interface 110. The motor may control the rack 106 and pinon 108 to translate the camera 112 through the cover 102 so that the one or more flaps rotate to the open position exposing the camera lens as shown in FIG. 2.

FIG. 2 illustrates the vehicle camera system 100 of FIG. 1 depicting the cover 102 in the open position. The vehicle camera system 100 in the open position may have the flaps 102a through 102d (collectively 102) of the cover 102 exposing the camera lens 103. The cover 102 may have the flaps 102a through 102d rotate to the open position based on the rack 106 and pinion 108 translating the camera 112 through the cover 102. The cover 102 may have a material at the outer layer 105 configured to protect the camera 112 from the environment and a fiber material on the inner layer 101 configured to contact (e.g., clean) the camera lens 103 as the camera 112 extends from the inward position to the outward position.

In another example, a driver may request that the vehicle camera system 100 to execute the clean lens application via a clean camera request received at a user interface. The vehicle camera system 100 may control the motor to cycle the rack 306 and pinion 308 such that the camera lens 103 moves across the flaps 102a through 102d while the camera extends from the inward position to the outward position. The camera lens 103 cycling between the inward and outward positions allows the fiber material located in the inner layer 101 of the cover 102 to remove debris from the camera lens 103.

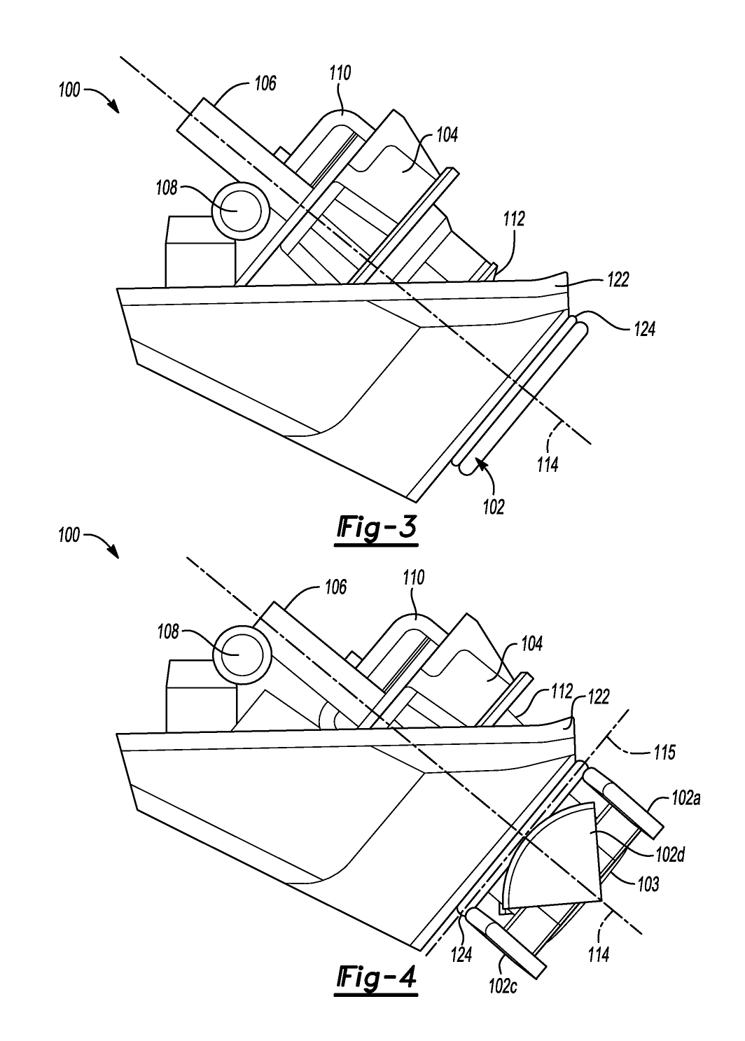

FIG. 3 illustrates a side view of the vehicle camera system 100 as depicted in FIG. 1. The vehicle camera system 100 is illustrated with the camera 112 in the inward position so that the camera lens 103 is enclosed by the cover 102. The housing 122 has an inner edge 124 defining the opening 126 for the camera 112. The housing 122 may have one or more tabs (not shown) so that the vehicle camera system 100 may be coupled to the vehicle 31. For example, the housing 122 may be coupled to a rear bumper of the vehicle 31 via the one or more tabs.

As shown in FIG. 3, the camera cover system 100 illustrates the rack 106 positioned along an axis 114. The rack 106 may move along the axis 114 via the pinon 108 to translate the camera 112 to the outward position. For example, the vehicle camera system 100 may receive an operable command from the vehicle computing system. In response to the received operable command, the motor may control the pinion 108 to extend the rack 106 along the axis 114 exposing the camera lens 103 as shown in FIG. 4.

FIG. 4 illustrates the side view of the vehicle camera system 100 as depicted in FIG. 2. The one or more flaps 102a through 102d are hinged to rotate in an open position of the vehicle camera system 100 exposing the camera lens 103. As shown in FIG. 4, the rack 106 is moved along the axis 114 so that the camera 112 is extended through the cover 102. While the cover 102 is biased towards the closed position, the one or more flaps 102a through 102d are configured to enable the camera 112 to move through the cover 102. The one or more flaps 102 are adjacent to each other to allow a shroud over the camera lens 103. The one or more flaps 102a through 102d may be rotatable about an axis 115 tangential the inner edge 124 from the closed to open position.

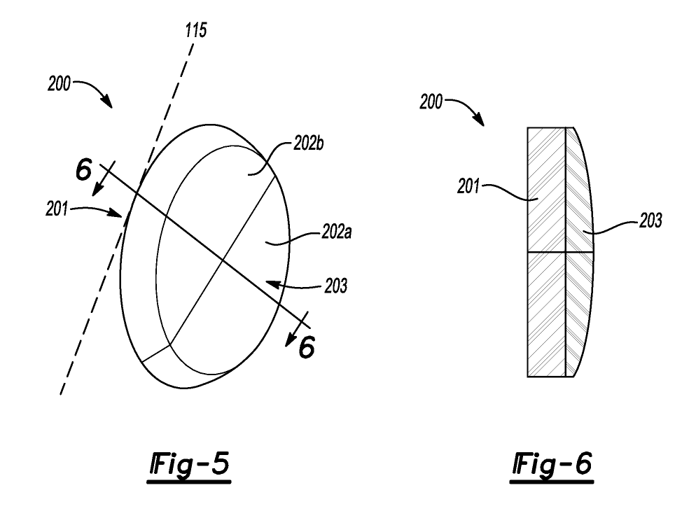

FIG. 5 illustrates a perspective view of a cover 200 in the closed position in accordance with one embodiment of the present disclosure. The cover 200 includes two flaps 202a and 202b. In other embodiment, the cover 200 may be configured with one or more flaps 202 that are adjacent to each other to enclose the camera in the inward state. The one or more flaps 202 may have at least two layers. The two layers may include an inner layer 201 and an outer layer 203.

As shown in FIG. 5, the one or more flaps 202a through 202b (collectively 202) of the cover 200 are configured to be adjacent to each other for enclosing the camera 112 in the closed position. The inner layer 201 faces the camera lens 103 and is configured with one or more opaque materials that contact the camera lens 103 to remove debris. For example, the inner layer 201 contacts the camera lens 103 when the camera 112 translates between the inward and outward positions, and vice versa.

The outer layer 203 encloses the camera lens 103 when the camera 112 is in the inward position. The outer layer 203 is formed of a material for providing protection to the vehicle camera system from the environmental conditions and elements that are located at the exterior of the vehicle. For example, if the vehicle is driving down an unpaved road (e.g., dirt road), and the camera 112 is in the inward position, the outer layer 203 of the cover may prevent dust and/or debris from contacting the camera lens. In another example, if it is raining while the camera 112 is in the outward position, the inner layer 201 may remove moisture from the camera lens 103 while the one or more flaps are rotating back to the closed position based on an inoperable state request.

FIG. 6 illustrates a cross section view of the cover 200 in the closed position depicted in FIG. 5 and taken along line 6-6. The inner layer 201 of the cover 200 may be configured with cleaning fibers such as nylon, Kevlar™, and/or polyester. The fiber material may contact the camera lens 103 so that the microfiber is able to absorb oily matter, remove moisture, and/or remove dust without being abrasive as the camera 112 translates from closed to open positions, or vice versa. The outer layer 203 of the cover 200 may be configured with materials such as polyethylene, polypropylene, polyvinyl chloride, polyamide, and/or polysulfones. The outer layer 203 may be flexible enough to allow the cover 200 to outwardly rotate to the open position when the camera 112 comes into contact with the cover 200.

In one embodiment, the outer layer 203 is thicker than the inner layer 201. The outer layer 203 may have a thickness in the range of 1 millimeters to 15 millimeters. The inner layer 201 may have a thickness in the range of 0.5 millimeters to 10 millimeters. For example, the outer layer 203 may have a thickness of 3 millimeters while the inner layer has a thickness of 1 millimeter. The inner layer 201 has one outer surface formed of a soft material that comes into contact with the camera lens and an opposing surface including an adhesive to adhere the inner layer 201 to the outer layer 203. The outer layer 203 has an inner surface to receive the adhesive from the inner layer 201 and an opposing surface that is formed with one or more materials to reduce contamination from the external environment when the camera is in the inward state.

The thickness of each layer may depend on the material(s) selected for the cover. In one example, the outer layer that is formed of a rigid polymer material having a thickness in a range of 2 millimeters to 4 millimeters, and the inner layer is formed of a nylon fiber having a thickness in a range of 1 millimeter to 3 millimeters.

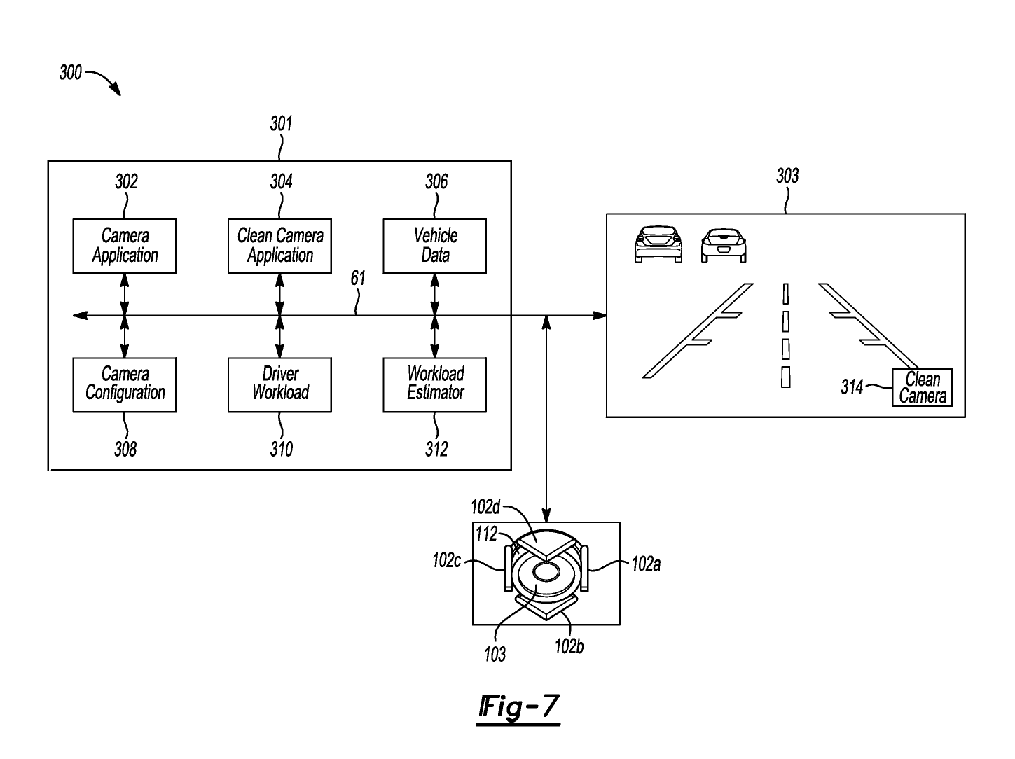

FIG. 7 illustrates an exemplary vehicle camera system 300. As illustrated, the system 300 may include a camera 112 connected to a vehicle computing system (VCS) 301. The VCS 301 may include a processor that controls at least some portion of the operation of the vehicle-based computing system. Provided within the vehicle, the processor allows onboard processing of commands and routines. Further, the processor is connected to both non-persistent and persistent storage. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The camera 112 is configured with the cover 102 having one or more flaps 102a through 102d. The one or more flaps 102a though 102d may enclose the camera 112 when in an inoperable state. As shown in FIG. 7, the camera 112 is in an operable state, therefore in an outward position exposing the camera lens 103. The system 300 further includes a camera application 302 of the VCS 301 configured to access the camera 112, to transmit commands to the camera 112, and to receive data from the camera 112 via a vehicle network 61.

The camera application 302 may be configured to control and/or configure one or more camera features via camera configuration settings 308. Each camera configuration setting 308 may be associated with one or more triggers related to driver workload 310, a workload estimator 312, and/or vehicle data 306.

For example, in response to the VCS 301 detecting vehicle data 306 associated with a reverse gear selection, the camera application 302 may control the camera 112 from the inoperable state to an operable state by moving the camera 112 through the cover 102. The operable state (e.g., cover 102 in an open position) exposes the camera lens 103 so that the camera 112 may transmit captured images to a display 303 via the vehicle network 61.

The system may include a clean lens application 304 that is configured to determine whether the camera lens contains debris. The clean lens application 304 may cycle the camera 112 to translate from the inward and outward positions causing the one or more flaps 102a through 102d of the cover 102 to open and close contacting the camera lens 103 based on detection of debris. The clean lens application 304 may determine debris based on the quality of the captured imagine. The clean lens application 304 may contain software to determine debris at the lens based on brightness, clarity, object recognition, and/or a combination thereof. For example, if the clean lens application 304 detects moisture and/or dirt on the camera lens, the clean lens application 204 may transmit a message to the camera application 302 to cycle the camera to translate (e.g., extend) through the cover for a predefined number of times. In another example, the clean lens application 304 may delay the cleaning cycle based on received vehicle data 306 containing information that the VCS 301 is using the camera (e.g., the vehicle is moving in reverse), therefore the driver may be using the camera.

The system 300 further includes a workload estimator 312 configured to receive vehicle data 306 and to determine driver workload 310. The driver workload 310 may measure if the vehicle is in an acceptable condition to launch the clean lens application 304 based on the vehicle data 306. The vehicle data 306 may include, but is not limited to, transmission gear, vehicle speed, and/or a combination thereof. For example, the system 300 may exit out of the clean camera application 304 if a driver workload 306 exceeds a vehicle speed threshold value (e.g., greater than zero miles per hour).

The vehicle camera system 300 may provide a user initiated clean request 314 message for the clean lens application 304. For example, a clean camera request 314 may be a touch screen input selection displayed at the user interface 303. In another example, the clean camera request 314 may be a switch, soft key, or a hard key input. In response to the user selecting the clean camera request 314, the system 300 may begin to cycle the camera 112 to move from the inward to outward positions so that the one or more flaps 102a through 102d move from the open and close positions for a predetermined amount of cycles.

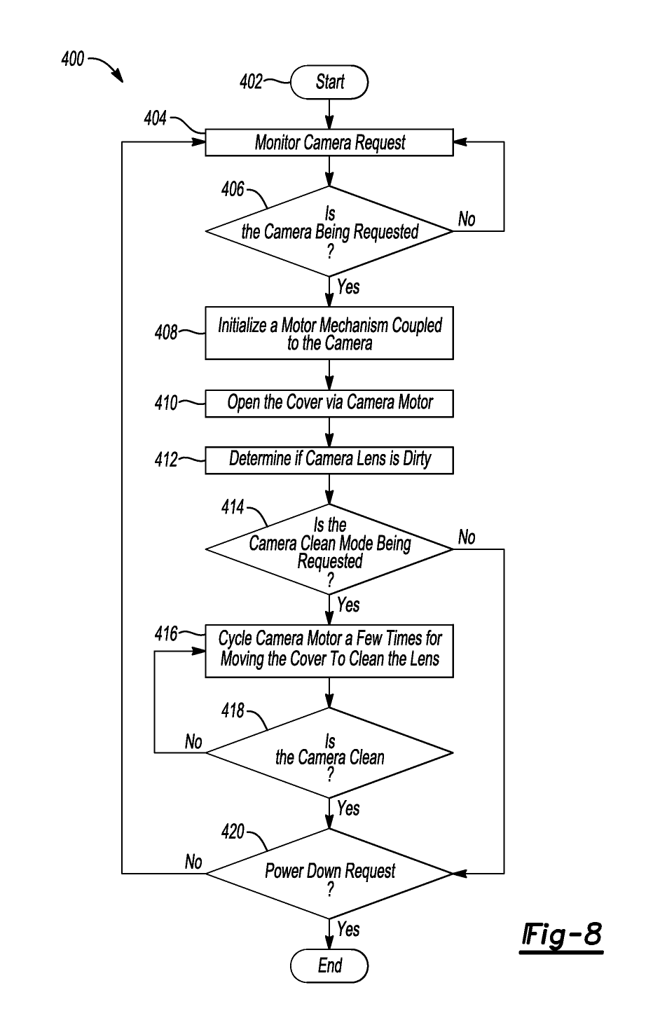

FIG. 8 illustrates an exemplary method for control of a vehicle camera system with an enclosure. The method 400 may be implemented using software code contained within the VCS 301. In other embodiments, the method 400 may be implemented in other vehicle controllers, or distributed among multiple controllers in communication with the VCS 301.

Referring again to FIG. 8, the vehicle camera system and its components illustrated in FIG. 1 through FIG. 7 are referenced throughout the discussion of the method to facilitate understanding of various aspects of the present disclosure. The method 400 of shielding and cleaning a vehicle camera may be implemented through a computer algorithm, machine executable code, or software instructions programmed into a suitable programmable logic device(s) of the vehicle, such as the vehicle control module, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the vehicle camera system 300 may execute the camera application 302 based on a power on request of the VCS 301. For example, the VCS 301 may be initialized based on a key-on request. The camera application 302 may be executed based on a request to enable the camera for assisting the driver. The VCS 301 may monitor if the camera is being requested in operation 404.

In operation 406, the system 300 may determine if the camera 112 is being requested. For example, the vehicle camera system 300 may receive a request signal notifying the need for the camera 112 located on the rear bumper of the vehicle to assist the driver based on the selection of reverse gear for the vehicle transmission. In response to the camera 112 being requested, the camera lens 103 located at the rear bumper may transmit images for display at the user interface 303 via the vehicle network 61.

In operation 408, in response to the camera 112 being requested, the system 300 may initialize a motor mechanism coupled to the camera 112. For example, the motor mechanism may include the rack 106 and pinion 108 configured to move the camera 112 to an open (e.g., operable state) and closed (e.g., inoperable state) positions via the motor. The closed position is configured so that the rack 106 and pinion 108 are at a retracted state allowing the cover to extend across the opening 126 for the camera lens 103. The system 300 may telescope the camera 112 to move from the closed position to an open position such that the one or more flaps 102a through 102d of the cover 102 are outwardly rotated. The motor mechanism extends the camera 112 through the cover 102 via the rack 106 and pinion 108 so that the camera 112 causes the one or more flaps 102a through 102d to rotate to an open position exposing the camera lens 103 in operation 410.

In operation 412, the system 300 may determine if the camera lens 103 is dirty. The system 300 may determine if the camera lens 103 has debris based on one or more algorithms, sensors, and/or a combination thereof. The one or more algorithms include, but are not limited to, imagine recognition, brightness, clarity, and/or a combination thereof. For example, the system 300 may determine that it is raining based on a rain sensor located near the windshield. The system 300 may perform a lens cleaning cycle to ensure the camera lens 103 is free from water spots caused by the rain.

In operation 414, the system 300 may determine if a camera clean mode is being requested. For example, the clean camera application may be automatically initiated based on the detection of debris at the camera lens 103. In another example, the clean camera application 304 may be manually initiated by the driver based on input at the user interface display 303.

In operation 416, in response to a camera clean mode request, the system 300 may cycle the motor mechanism coupled to the camera 112 one or more times so that the one or more flaps 102a through 102d of the cover 102 contacts the camera lens 103. The system 300 may determine if the camera 112 is clean after the camera clean mode has cycled the motor mechanism for a predefined number of times in operation 418. If the system 300 determines that the camera 112 is not clean, the system 300 may continue to cycle the motor mechanism for a predefined amount of times.

In operation 420, the system 300 may determine if a power down is being requested of the VCS 301. For example, the VCS 301 may be requested to power down based on a key-off request. In response to the power down request, the system 300 may store the one or more variables associated with the camera system in non-volatile memory. If a power down request is not recognized, the system 200 may continue to monitor for a camera request.

The vehicle camera system provides a cover 102 configured to prevent buildup of film, grit and/or dirt on the camera lens 103. The cover 102 having one or more flaps 102a through 102d may enclose the camera 112 while in an inoperable state. The one or more flaps 102a through 102d may contact the camera lens 103 to partially remove film, grit and/or dirt when the camera moves into the operable state. The cover 102 provides a solution to enclose and clean the camera lens 103.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle camera enclosure for enclosing a vehicle camera comprising:
a housing including an inner edge defining an opening; and
a cover extending across the opening, the cover outwardly rotatable away from the inner edge from a closed position to an open position.

2. The vehicle camera enclosure of claim 1, wherein the cover is biased towards the closed position.

3. The vehicle camera enclosure of claim 1, wherein the cover including two or more flaps.

4. The vehicle camera enclosure of claim 3, wherein each flap is rotatable about the inner edge from a closed position to an open position.

5. The vehicle camera enclosure of claim 3, wherein each flap is biased towards the closed position.

6. The vehicle camera enclosure of claim 3, wherein adjacent flaps contact each other.

7. The vehicle camera enclosure of claim 1, wherein the cover is rotatable about an axis tangential the inner edge from the closed to the open positions.

8. A vehicle camera enclosure for enclosing a vehicle camera comprising:
a housing including an inner edge defining an opening; and
a cover extending across the opening and including inner and outer layers of different opaque materials.

9. The vehicle camera enclosure of claim 8, wherein the inner layer is formed of a fiber material.

10. The vehicle camera enclosure of claim 9, wherein the vehicle camera is translatable between inward and outward positions, the vehicle camera has a lens, and the fiber material contacts the vehicle camera lens while the vehicle camera translates from the inward position to the outward position.

11. The vehicle camera enclosure of claim 9, wherein the inner layer faces the vehicle camera lens.

12. The vehicle camera enclosure of claim 9, wherein the fiber material is Kevlar™ or nylon.

13. The vehicle camera enclosure of claim 8, wherein the outer layer is formed of a rigid polymer material.

14. The vehicle camera enclosure of claim 13, wherein the rigid polymer material is polyethylene or polypropylene.

15. A vehicle camera system comprising:
a camera translatable between inward and outward positions; and
an enclosure at least partially enclosing the camera and having an opening and a cover extending across the opening, the cover having closed and open positions.

16. The vehicle camera system of claim 15, wherein the opening is bounded by an opening edge and the cover is mounted to the opening edge.

17. The vehicle camera system of claim 16, wherein the cover rotates outward when the camera translates between the inward and outward positions.

18. The vehicle camera system of claim 16, wherein the cover includes two or more flaps, each flap rotates outward when the camera translates between the inward and outward positions.

19. The vehicle camera system of claim 15, wherein the cover is in the closed position when the camera is in the inward position.

20. The vehicle camera system of claim 15, wherein the cover is in the open position when the camera is in the outward position.
